(19) United States
(12) Patent Application Publication
(10) Pub. No.: US 2015/0142584 A1
(43) Pub. Date: May 21, 2015

(54) RANKING CONTENT BASED ON MEMBER PROPENSITIES

(71) Applicant: LinkedIn Corporation, Mountain View, CA (US)

(72) Inventors: Haishan Liu, Sunnyvale, CA (US); Baoshi Yan, Belmont, CA (US); Anmol Bhasin, Los Altos, CA (US); Christian Posse, Foster City, CA (US)

(73) Assignee: LinkedIn Corporation, Mountain View, CA (US)

(21) Appl. No.: 14/083,103

(22) Filed: Nov. 18, 2013

(51) Int. Cl. G06Q 30/02

(52) U.S. Cl. CPC G06Q 30/0269
USPC 705/14.69

(57) ABSTRACT

A system, apparatus, method and computer-program product are provided for determining affinities between members of an on-line service and/or one member's likely propensity for content published by or on behalf of another member. Members of the service include individuals and organizations. A content item may be an announcement by or for a member, an advertisement, a job listing or something else. Content items available for service to an individual member are ranked based on the member's propensity for consuming them, as reflected in scores computed for each item. An item's propensity score may be calculated based on the relevance and/or proximity between the member and an organization featured in or associated with the item. Relevance may measure the similarity between profiles of the individual and the organization. Proximity may be affected by whether the individual and/or associates of the individual follow the organization, visit a page of the organization, etc.

### BACKGROUND

A system, apparatus, method and computer-program product are provided for ranking, by propensity, content items available for serving to members or users of an online service.

When an online service or application distributes content to users, it often simply sends to a given user all applicable content in the order in which it is received for distribution. Therefore, the user may receive a sequence of random content items, with individual items have varying significance or interest for him or her.

The user must therefore review each item, even those that hold absolutely no interest, to avoid overlooking a particularly interesting item that may have been inserted in the midst of a stream of uninteresting items. Having to attend to each item, even those that he or she finds annoying, may detract from the user's enjoyment of the service and/or cause him or her to miss content that is desired.

### DESCRIPTION OF THE FIGURES

FIG. 1 is a block diagram depicting a system for ranking, by member propensity, content to be served by the system to the member, in accordance with some embodiments.

FIG. 2 is a flow chart demonstrating a method of ranking, by member propensity, content to be served to the member by an online system or service, in accordance with some embodiments.

FIG. 3 is a block diagram of an apparatus for ranking, by member propensity, content to be served to the member by the apparatus, in accordance with some embodiments.

### DETAILED DESCRIPTION

Embodiments of a system, apparatus, method and computer-program product are provided for ranking, by member propensity, content to be served by the system to those members. In these embodiments, a given user's (or member's) affinities with subjects of the content may be applied to determine which content items to present to him and/or order them in a particular sequence (e.g., according to the user's propensity to act on them).

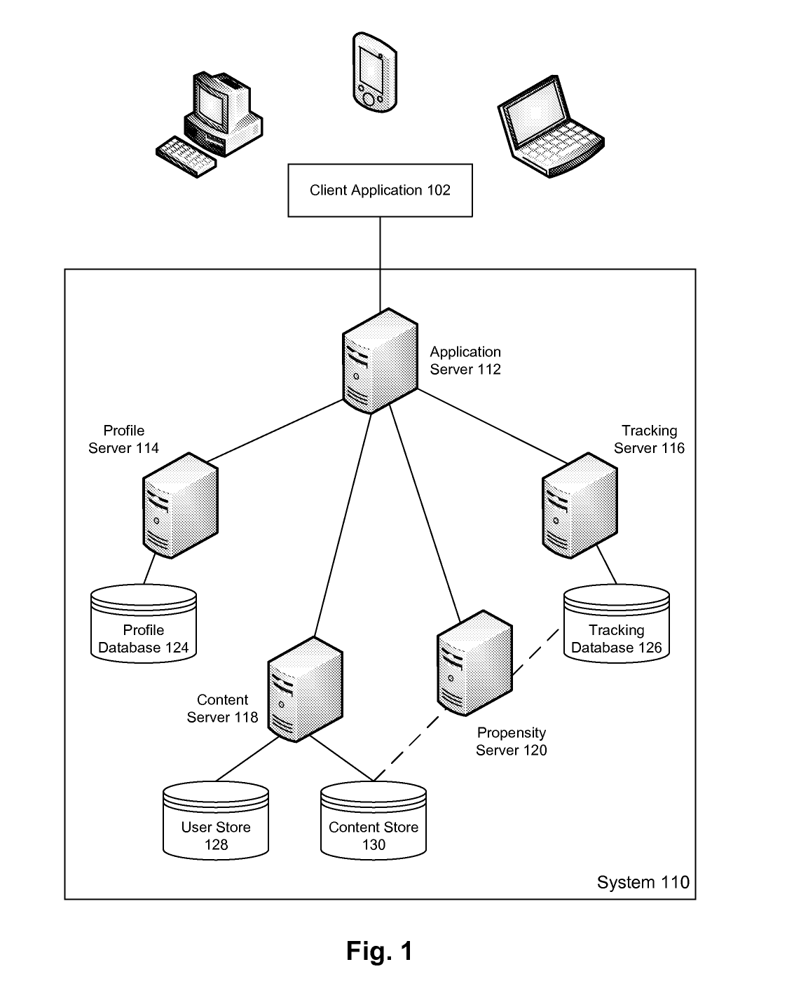

FIG. 1 is a block diagram depicting a system for ranking, by member propensity, content to be served to the member by the system, according to some embodiments.

System 110 hosts an online service or application for use by operators or users of client devices that execute a compatible client application 102. A client device may be stationary (e.g., desktop computer, workstation) or mobile (e.g., smart phone, table computer, laptop computer), and client application 102 may be a browser program or an application designed specifically to access the service(s) offered by system 110. Users of system 110 may be termed members because they may be required to register with the system in order to fully access system services.

User connections are generally made through application server 112, which may comprise a portal, web server, data server and/or some other gateway or entry point. System 110 also includes profile server 114, tracking server 116, content server 118, propensity server 120, profile database 124, tracking database(s) 126, user data store 128 and content store 130.

In some specific embodiments, system 110 hosts a professional social networking service or site that allows and helps members to create, develop and maintain professional (and personal) relationships. As part of the service, system 110 serves content for presentation to members via the client application, which may include content generated or suggested by other members (e.g., images, video, audio, messages), offers, advertisements, announcements, job listings, status updates, and so on.

Profile server 114 maintains profiles, in profile database 124, of members of the service hosted by system 110. An individual member's profile may reflect any number of attributes or characteristics of the member, including personal (e.g., gender, age or age range, interests, hobbies), professional (e.g., employment status, job title, functional area, employer, skills, endorsements, professional awards), social (e.g., organizations the user is a member of, geographic area of residence, friends), educational (e.g., degree(s), university attended, other training), etc.

Organizations may also be members of the service, and may have associated descriptions or profiles comprising attributes such as industry (e.g., information technology, manufacturing, finance), size, location, goal, etc. An “organization” may be a company, a corporation, a partnership, a firm, a government agency or entity, a not-for-profit entity, an online community (e.g., a user group), or some other entity formed for virtually any purpose (e.g., professional, social, educational).

Members of the service have corresponding pages (e.g., web pages, content pages) on system 110, which they may use to facilitate their activities with the system and with each other. These pages are available to some or all other members to visit in order to browse messages, announcements and/or other information provided by the corresponding member.

Tracking server 116 monitors and records (e.g., in tracking database(s) 126) activity of system 110 and/or members. For example, whenever content is served from application server 112 or content server 118 (e.g., to a client device), the tracking server records what is served, to whom (e.g., which member), and when. Similarly, the tracking server also records member actions regarding advertisements and/or other content presented to the members, to include identities of the member and the content acted upon, what action was taken (e.g., click, conversion, follow-on request, visiting a page associated with a subject or provider of the content), when the action was taken, etc.

Content server 118 maintains one or more repositories of content items for serving to members (e.g., content store 130), an index of the content items, and user store 128. Content store 130 may include various types of content and content items, including advertisements (e.g., both revenue and non-revenue ads), information (e.g., announcements, messages) released by members (and possibly non-members), status updates, job listings, media content (e.g., images, video, audio), documents, and so on, for serving to members and/or for use by various components of system 130. Content server 118 (or some other component of system 110) may include a recommendation module for recommending content to serve to a member.

When content is stored in content store 130, it may be stored with attributes, indications, characteristics and/or other information describing one or more target audiences of the content. For example, a provider of an advertisement may identify relevant attributes and desired values of target members, a provider of a job listing may identify attributes of members that should be informed of the opening, an organization wishing to obtain more followers/subscribers/fans may identify the type(s) of members it would like to attract, and so on.

Content items received or generated by system 110 for distribution to members may be maintained in one or more queues, in addition to or instead of in content store 130. For example, new content items may be queued and considered for service to members for some period of time, after which they may be archived or placed in content store 130 or some other long-term store.

User store 128 stores, for each member of the service hosted by system 110, a record of content items served to the member, or served for presentation to the member, and when they were served. In particular, user store 128 may be configured to allow the content server and/or other components of system 110 to quickly determine whether a particular content item was previously presented to a particular member, how many times it was presented, when it was presented, how it was presented (e.g., how prominently or where it was presented within a web page or other page of content), and/or other information. Although some of this data may duplicate what is stored by tracking server 116, contents of user store 128 are rapidly accessible to one or more servers (especially content server 118), and may be used to help select a content item to serve in response to a current request.

As described in more detail below, propensity server 120 determines members' affinities with subjects featured in or associated with content available for serving to members, or propensities for consuming that content. For example, propensity server 120 may rank multiple content items with regard to a particular individual member's propensity for engaging with those items, to determine whether to serve them to that member and, if they are served, to indicate an order in which they should be served.

System 110 may include other components not illustrated in FIG. 1. Also, or alternatively, the functionality of the system may be distributed among the illustrated components in an alternative manner, such as by merging or further dividing functions of one or more components, or may be distributed among a different collection of components. Yet further, while implemented as separate hardware components (e.g., computer servers) in FIG. 1, one or more of application server 112, profile server 114, tracking server 116, content server 118 and propensity server 120 may alternatively be implemented as separate software modules executing on one or more computer servers.

In some embodiments, propensity server 120 is configured to select and/or order content items for presentation to a member based on affinities between the member and subjects of or associated with the items, or based on propensities of the member to engage with the content items (e.g., by reading them, clicking on them, forming a relationship with the subject if they do not already have a relationship).

In these embodiments, system 110 presents individual members with streams of content items featuring or associated with other members and/or non-member entities. An individual content item may be generated by or on behalf of a member featured in the item, and may include text, audio, an image and/or video. Illustrative content items are messages or announcements regarding new relationships between members, updates regarding members' statuses or profiles, new products or offers, advertisements, job listings, and/or other professional (or personal) developments.

Specific content items will likely be of more interest to some members than others. In particular, a content item produced by a member organization may be of much more interest to individual members who follow that organization, work for that organization or wish to join the organization. Other individual members who have no connection with the organization, and are not interested in the organization's purpose or the industry in which the organization operates, are likely to have little or no interest in the content item.

As previously described, system 110 (e.g., content server 118) maintains one or more collections of content items received or generated for distribution to members of the online service. For some or all individual members, propensity server 120 separately ranks or rates those items regarding propensities of the individual members to act on them, or affinities between those individual members and subjects featured in or associated with the items. Resulting “propensity scores” may be used to select which items to present to a given user and/or to order them for presentation to that user.

Affinity between a given member and a subject of a content item, or the member's propensity to engage with the content item, may be determined in different ways in different embodiments. In some embodiments, primary factors for determining a member's affinity or propensity include the “relevance” of the subject to the member and the “proximity” of the subject to the member.

In some implementations, the relevance of the subject of a content item to an individual member is proportional to the degree of similarity or overlap between the member's profile and a profile or description of the subject. For example, the more terms that appear in both the member's profile (e.g., regarding the member's attributes, relationships, interests) and the subject's profile or description, the greater the relevance. Therefore, if the subject is a company within a particular industry, and the member works for another member of that industry (or possibly even the company itself), or if the member's job or functional area matches the subject's industry, higher relevance will be found than if the member and subject represent two different industries or professions.

Similarly, propensity server 120 may compare announcements regarding the subject (e.g., news releases, new products, company updates) with the member's profile, may determine whether the member has ever searched the online service for the subject (e.g., to locate the subject's corresponding page).

In some implementations, a “virtual” profile of the subject is created (or expanded if a real profile already exists). In these implementations, a subject's virtual profile may incorporate attributes, behavior, interests and/or other components of profiles of individual members that follow the subject (especially components that are common to multiple members that follow the subject). Use of a virtual profile may be particularly worthwhile if the subject provides only a minimal description of itself, or only partially completes a regular profile.

Measuring the proximity between an individual member and the subject of a content item may involve determining whether the member follows (or “likes”) the subject, whether associates and/or friends of the member follow the subject, whether the member (and/or friends and associates) have browsed a page of the service dedicated to the subject, whether they are likely to, etc. To determine whether the member or a friend/associate of the member is likely to visit (or be interested in) the subject's page, the propensity server may identify other members that visited the same set of pages as the member (and/or the member's friends/associates), or a subset thereof, and identify other pages those other members visited. If those other pages include the subject's page, the proximity between the member and the subject is considered higher than it would be otherwise.

Based on the relevance and proximity between a member and a subject, two feature vectors are assembled, one for the member and one for the subject, and will be used to generate a numerical propensity score. In some implementations, a feature vector comprises multiple dimensions, each dimension corresponding to a particular attribute (e.g., of a profile of a member of a professional social networking service, of a subject's virtual profile). For example, a member's feature vector might include “information technology” for an “industry” attribute and “Northern California” for a “geographic location” attribute. Similarly, a subject (e.g., a specific company) might have “finance” as its value for the industry attribute and “Northern California” for its geographic location attribute.

The similarity between a given member and a given subject can then be computed from their feature vectors to produce a propensity score that is proportional to the degree of correlation between the vectors. For example, the greater the number of dimensional matches between the member's feature vector and the subject's feature vector, the greater the member's propensity score for that subject.

In a simplistic application, the member's propensity score is increased by one for every vector dimension in which the member's and subject's values match. In different implementations, the feature vectors may be processed with different techniques to yield the propensity score (e.g., cosine similarity, weighted combination, machine-learning model). Propensity scores may be normalized to yield a value between 0 and 1.

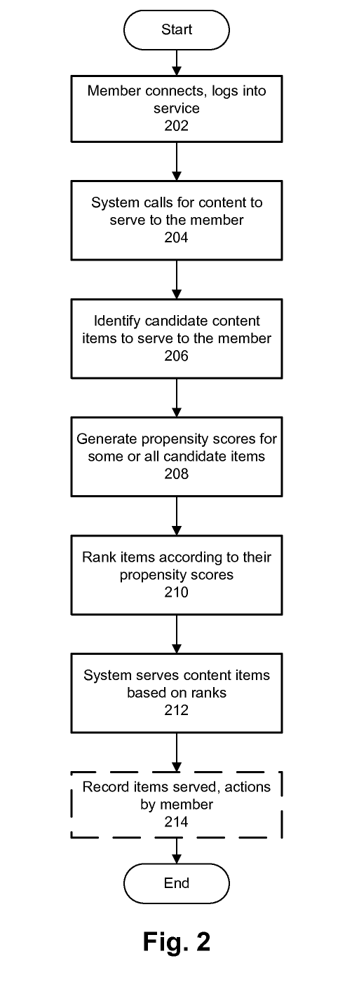

FIG. 2 is a flow chart demonstrating a method of ranking, by member propensity, content to be served to the member by an online system or service, according to some embodiments.

In operation 202, an individual member of an online service (e.g., a professional networking site) connects and logs into the service.

In operation 204, a component of the system (e.g., an application server, a web server, propensity server 120 of FIG. 1) calls for content items to serve to the member. The items may be intended to be served in a streaming format, so that the member can scroll through the items as desired, and may be formatted to fill an entire page of content presented to the member, or just a frame or portion of the page.

In operation 206, a list or set of candidate content items is identified. The number of candidate content items (or a maximum or minimum number of items) may or may not be predetermined. For example, the system may simply identify the most recent X items received or generated by the system, or may automatically identify all items received or generated by the system within the last 2 days, the last 12 hours or some other period of time.

In operation 208, for each candidate item, the system (e.g., a propensity server) calculates a propensity score. As discussed above, an item's score may depend on the relevance of the item (or a subject of the item) to the member, proximity of the content item's subject to the member, and/or other factors.

In some embodiments, some items may be filtered out of consideration before propensity scores are calculated. For example, if an individual member indicates that he or she never wants to see items that feature a particular subject, content items featuring that subject may be filtered out. Or, an organization member may indicate that a particular content item produced by that member should not be shown to particular types of individual members (or, conversely, should only be shown to a particular type of member—such as members having certain attributes).

As discussed above, an item's calculated propensity score is intended to reflect a propensity of the member to act on, or at least be interested in, the content item. Thus, items that feature subjects with which the member already has relationships will likely receive relatively high scores, while items that feature subjects that have no relation to the member will likely receive low scores.

In operation 210, some or all of the candidate items are ranked according to their propensity scores. Illustratively, those at or below a minimum threshold may be automatically eliminated from consideration (meaning that they will not be served to the member).

In operation 212, the system begins serving content items to the member based on the items' ranks. The system may simply serve the top N items, and serve another N items if the member scrolls through them, may stream some number M of items that the member scrolls through, or may serve them in some other way. The propensity-score based ranks will determine, however, the order in which they are served.

In optional operation 214, the system records the items served to the member, along with any reaction or engagement of the items by the member. Thus, if the member clicks on an item, browses to a page of a subject of an item, or takes some other significant and related action, the system will record it.

In some embodiments, the system does not record an item as having been served until it actually appears on a display component of the member's client device. For example, a stream of multiple items dispatched to the client device may include too many items to display at one time. Only as the member scrolls through the items (or the items scroll automatically) and individual items are displayed are the items recorded as having been served. Illustratively, some or all content items may have small trigger elements (e.g., single pixels) that actuate when the items are displayed, and that notify the system that they have been presented.

The method illustrated in FIG. 2 and described above is but one method by which a system or service that presents content items to members may generate propensity scores in order to rank and order the items for presentation. In other embodiments, the same and/or different operations may be performed in a similar or different manner to obtain a similar result, as will be understood by one of ordinary skill in the art. For example, instead of a “pull”-type method of operation in which members connect to the system and receive content, from the preceding discussion a method may be derived to “push” appropriate content to members or system users who are not currently connected to the system (e.g., via electronic mail or other communication).

The method of FIG. 2 may be repeated on a regular or irregular basis, such as every time a member connects to the system. As one alternative, content items may be scored and ranked for a given member in an offline mode, and the results used when that member connects or re-connects.

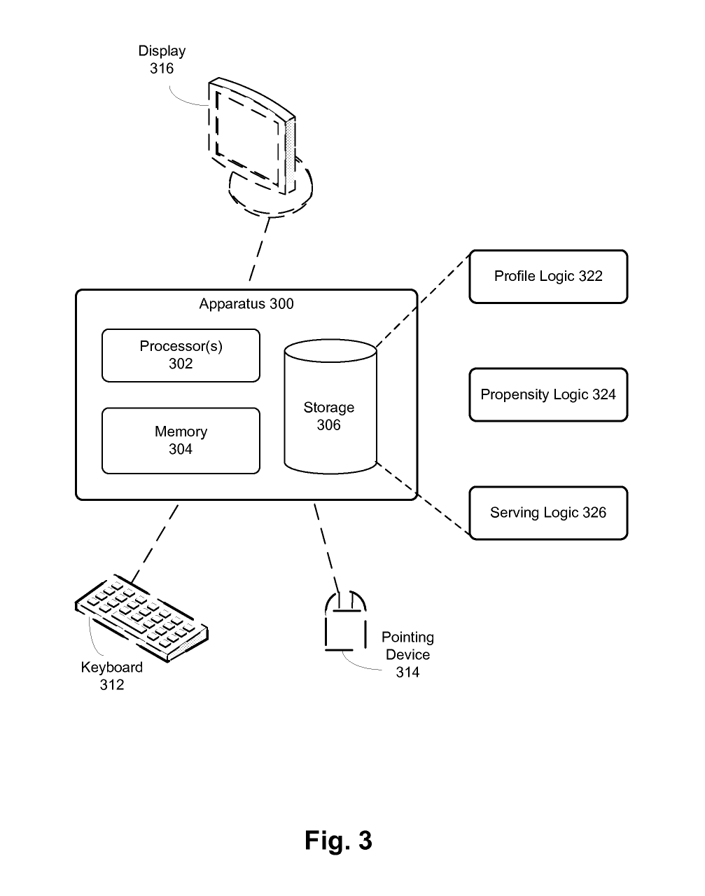

FIG. 3 is a block diagram of an apparatus for serving content items to a member based on calculated propensity scores, according to some embodiments.

Apparatus 300 of FIG. 3 comprises processor(s) 302, memory 304 and storage 306, which may comprise one or more optical, solid-state and/or magnetic storage components. Apparatus 300 may be coupled (permanently or transiently) to keyboard 312, pointing device 314 and display 316.

Storage 306 of the apparatus may store content for serving to/for members, member data (e.g., profiles), tracking data and/or other information. Storage 306 also stores logic that may be loaded into memory 304 for execution by processor 302. Such logic includes profile logic 322, propensity logic 324 and serving logic 326. In other embodiments, any or all of these logic modules or other content may be combined or divided to aggregate or separate their functionality as desired.

Profile logic 322 comprises processor-executable instructions for assembling or populating member profiles. In some implementations, logic 322 solicits members and receives information for populating their profiles with various attributes that reflect their professional, personal, social, educational and/or other aspects, etc.

Propensity logic 324 comprises processor-executable instructions for generating propensity scores for content items available for serving to members of a service hosted by apparatus 300. In some implementations, the propensity logic identifies or receives content items that are candidates for serving to some or all members. For each such content item, the logic calculates a propensity score based on relevance (e.g., relevance of the subject of a content item to a member), proximity (e.g., level or degree of contact or separation between the subject of a content item and a member) and/or other factors. Propensity logic 324 also ranks content items for serving to a member, based on the calculated propensity scores.

Serving logic 326 comprises processor-executable instructions for serving content items to members of the service hosted by apparatus 300. At least some items served by logic 326 are selected and ranked by propensity logic 324; other items may be selected for serving to a member in some other manner. Serving logic 326 (or other logic of apparatus 300) may track what is served, to whom it is served, record any action or engagement by the receiving member, etc.

In some embodiments of the invention, apparatus 300 performs most or all of the functions described in relation to system 110 of FIG. 1. In some particular implementations, apparatus 300 may host multiple virtual computer servers performing the functions of some or all of the servers of system 110.

An environment in which some embodiments of the invention are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which can be stored in a non-transitory computer-readable storage medium as described above. When a processor or computer system reads and executes the code and manipulates the data stored on the medium, the processor or computer system performs the methods and processes embodied as code and data structures and stored within the medium.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

1. A computer system-implemented method of ranking content for serving to individual members of a social networking service hosted by the computer system, the method comprising operating the computer system to:
for each of multiple content items available for serving to a first individual member of the service, wherein each content item features a subject organization:
measuring a relevance between the first individual member and the organization;
measuring a proximity between the first individual member and the organization, wherein the proximity is proportional to a level of contact between the first individual member and the organization, by:
determining whether the first individual member uses the service to follow the organization; and
identifying a number of associates of the first individual member that use the service to follow the organization;
wherein following the organization comprises automatically receiving announcements issued by the organization without having to search for the announcements; and
computing a propensity score for the first individual member for the content item by:
for the first individual member, constructing a first vector comprising N dimensions (N>1), each said dimension representing an attribute of a profile of the first individual member within the service;
for the subject, constructing a second vector comprising N dimensions, each said dimension corresponding to a dimension of the first vector and representing an attribute of a profile of the organization within the service; and
calculating a similarity between the first vector and the second vector;
wherein the propensity score comprises the calculated similarity;
ranking the multiple content items based on the computed propensity scores; and
serving a subset of the multiple content items to the first individual member in order of said ranking.

2. The method of claim 1, wherein measuring the relevance between the first individual member and the organization comprises:
matching terms of the profile of the first individual member with terms of the profile of the organization; and
determining whether the first individual member is employed in an industry that comprises the organization.

3. The method of claim 2, further comprising:
identifying multiple individual members of the service who browsed a page of the service dedicated to the organization, other than the first individual member; and
enhancing the profile of the organization with terms common to profiles of a subset of the multiple individual members.

4. The method of claim 2, wherein measuring the relevance between the first individual member and the organization further comprises:
matching terms of the profile of the first individual member with terms of an announcement issued by the organization.

5. The method of claim 2, measuring the relevance between the first individual member and the organization further comprises:
determining whether the first individual member used the service to conduct a search for the organization.

6. The method of claim 2, measuring the relevance between the first individual member and the organization further comprises:
determining whether the first individual member applied for a job with the organization.

7. (canceled)

8. The method of claim 1, wherein measuring the proximity between the first individual member and the organization further comprises:
determining whether the first individual member browsed a page of the service dedicated to the organization;
wherein the organization is a organization member of the service.

9. The method of claim 1, wherein measuring the proximity between the first individual member and the organization further comprises:
identifying one or more pages of the service browsed by the first individual member and associates of the first individual member; and
determining how often a page dedicated to the organization other than the one or more pages was browsed by members who browsed the one or more pages, other than the first individual member and associates of the first individual member.

10. The method of claim 1, wherein the service is a professional networking service that facilitates professional relationships between members of the service.

11. The method of claim 10, wherein the organization is an organization member of the service.

12. A non-transitory computer-readable medium storing instructions that, when executed by a processor, cause the processor to perform a method of ranking content for serving to individual members of a social networking service hosted by the computer system, the method comprising:
for each of multiple content items available for serving to a first individual member of the service, each content item featuring a different organization:
measuring a relevance between the first individual member and the organization;
measuring a proximity between the first individual member and the organization, wherein the proximity is proportional to a level of contact between the first individual member and the organization, by:
determining whether the first individual member uses the service to follow the organization; and
identifying a number of associates of the first individual member that use the service to follow the organization;
wherein following the organization comprises automatically receiving announcements issued by the organization without having to search for the announcements; and
computing a propensity score for the first individual member for the content item by:
for the first individual member, constructing a first vector comprising N dimensions (N>1), each said dimension representing an attribute of a profile of the first individual member within the service;
for the subject, constructing a second vector comprising N dimensions, each said dimension corresponding to a dimension of the first vector and representing an attribute of a profile of the organization within the service; and
calculating a similarity between the first vector and the second vector;
wherein the propensity score comprises the calculated similarity;
ranking the multiple content items based on the computed propensity scores; and
serving a subset of the multiple content items to the first individual member in order of said ranking.

13. A computer system for ranking content for serving to individual members of a social networking service hosted by the computer system, comprising:
one or more processors; and
memory configured to store instructions that, when executed by the one or more processors, cause the computer system to:
receive multiple content items for serving to the individual members, each content item featuring an organization member of the service;
for each of the multiple content items:
measure a relevance between a first individual member and the featured organization;
measure a proximity between the first individual member and the featured organization, wherein the proximity is proportional to a level of contact between the first individual member and the organization, by:
determining whether the first individual member uses the service to follow the organization; and
identifying a number of associates of the first individual member that use the service to follow the organization;
wherein following the organization comprises automatically receiving announcements issued by the organization without having to search for the announcements; and
compute a propensity score for the first individual member for the content item by:
for the first individual member, constructing a first vector comprising N dimensions (N>1), each said dimension representing an attribute of a profile of the first individual member within the service;
for the subject, constructing a second vector comprising N dimensions, each said dimension corresponding to a dimension of the first vector and representing an attribute of a profile of the organization within the service; and
calculating a similarity between the first vector and the second vector;
wherein the propensity score comprises the calculated similarity;
rank the multiple content items based on the computed propensity scores; and
serve a subset of the multiple content items to the first individual member in order of said ranking.

14. The computer system of claim 13, wherein the memory is further configured to store instructions that, when executed by the one or more processors, cause the apparatus to, for each of the multiple content items:
determine whether the first individual member browsed a page of the service corresponding to the featured organization; and
determine whether the first individual member searched the service for the featured organization.

15. The computer system of claim 14, wherein the memory is further configured to store instructions that, when executed by the one or more processors, cause the apparatus to, for each of the multiple content items:
determine whether the first individual member used to service to apply for a job opening associated with the featured organization.

16. The computer system of claim 13, wherein measuring the relevance between a first individual member and the featured organization comprises:
matching terms of a profile of the first individual member with terms of a profile of the featured organization; and
determining whether an industry in which the first individual member is employed comprises the featured organization.

17. (canceled)

18. The computer system of claim 13, wherein the service is a professional networking service that facilitates professional relationships between members of the service.

19. The computer system of claim 13, wherein measuring the relevance between a first individual member and the featured organization comprises:
generating a virtual profile for the featured organization by:
identifying multiple members of the service who follow the featured organization; and
populating the virtual profile with one or more components of profiles of the identified members; and
matching terms of a profile of the first individual member with terms of the virtual profile of the featured organization.

20. (canceled)

21. The method of claim 1, wherein:
the measured relevance is low due to low correlation between a profile of the first individual member and a description of the organization; and
the measured proximity is high because the organization is a first-degree connection of the first individual member.
